(19) United States
(12) Patent Application Publication
(10) Pub. No.: US 2026/0020000 A1
(43) Pub. Date: Jan. 15, 2026

(54) COORDINATING CARRIER USAGE IN MULTICARRIER SIDELINK

(71) Applicant: InterDigital Patent Holdings, Inc., Wilmington, DE (US)

(72) Inventors: Martino Freda, Laval (CA); Tuong Hoang, Montreal (CA); Faris Alfarhan, MONTRÉAL (CA); Tao Deng, New York, NY (US)

(73) Assignee: InterDigital Patent Holdings, Inc., Wilmington, DE (US)

(21) Appl. No.: 18/996,186

(22) PCT Filed: Aug. 5, 2023
(86) PCT No.: PCT/US2023/071752

§ 371 Date: Jan. 17, 2025

Related U.S. Application Data
(60) Provisional application No. 63/395,581, filed on Aug. 5, 2022.

(51) Int. Cl. H04W 72/02; H04L 1/1812; H04W 4/40; H04W 72/0453; H04W 72/25

(52) U.S. Cl. CPC H04W 72/02; H04L 1/1812; H04W 4/40; H04W 72/0453; H04W 72/25

(57) ABSTRACT

The disclosure pertains to an apparatus and a method implemented in a Wireless Transmit/Receive Unit (WTRU) for carrier coordination. The method includes receiving one or more preferred carriers associated with a second WTRU and triggering carrier reselection based on receiving the one or more preferred carriers. The method also includes performing carrier selection using the one or more preferred carriers, wherein the WTRU prioritizes the one or more preferred carriers through carrier selection criteria. The method further includes determining a number of carriers to select based on the one or more preferred carriers, and selecting one or more carriers based on the one or more preferred carriers, wherein the selected carrier are restricted based on the one or more preferred carriers. The method further includes sending unicast transmissions to the second WTRU using a selected resource of the first/second carrier. The method also includes sending groupcast/broadcast sidelink transmissions.

### CROSS-REFERENCE TO RELATED APPLICATIONS

This application claims the benefit of U.S. Provisional Patent Application No. 63/395,581, filed Aug. 5, 2022, the contents of which are incorporated herein by reference in their entirety.

### BACKGROUND

In the 3rd generation partnership project (3GPP) standard, a device-to-device direct communication link may be referred to as a sidelink. Similar to uplink and downlink, there is also control channel and data channel in sidelink. The control channel in sidelink may be referred to as Physical Sidelink Control CHannel (PSCCH), and the data channel in sidelink may be referred to as Physical Sidelink Shared CHannel (PSSCH). The PSCCH may be used to indicate time/frequency domain resource positions, modulation and coding mode, and priorities of data carried in PSSCH of PSSCH transmission, while PSSCH may be used to carry data.

Control information and data in Vehicle to Vehicle/Pedestrian/Infrastructure/Network or Vehicle to Everything (V2X) may be transmitted via sidelink, and at this time, the V2X communication may comprise two transmission modes: transmission mode 3 (Mode 3) and transmission mode 4 (Mode 4). With regard to Mode 3, transmission resource of PSCCH and PSSCH of one WTRU (referred to a V2X WTRU) may be allocated by an evolved Node B (eNB), and the WTRU may determine transmission resource of the PSCCH and the PSSCH by receiving a sidelink resource allocation indication transmitted by the eNB via a physical downlink control channel (PDCCH) or an Enhanced PDCCH (EPDCCH). In Mode 4, the transmission resource of the PSCCH and the PSSCH may be selected autonomously by the WTRU according to channel detection results. During the channel detection process, the WTRU may first determine time frequency resource position and priorities of scheduled PSSCH by receiving PSCCHs transmitted by other WTRUs, and then may further detect demodulation-reference signal received power of scheduled PSSCH (PSSCH-RSRP), and excludes the resource with PSSCH-RSRP higher than a particular threshold; and the WTRU then may calculate average received energy (S-RSSI) of the remaining resource, and may select one resource from those with the lowest S-RSSI as transmission resource.

### SUMMARY

Aspects of the present disclosure relate to carrier coordination, and, more particularly, to carrier selection and resource selection in multicarrier sidelink.

A Wireless Transmit/Receive Unit (WTRU), such as a first WTRU, may include a processor and a transceiver. Further, in some examples, a WTRU (e.g., a first WTRU) may be configured to perform a method that includes any combination of the following. The processor and the transceiver of the first WTRU may be configured to receive configuration information indicating carrier selection criteria. The processor and the transceiver of the first WTRU may be configured to receive a sidelink message from a second WTRU indicating a set of preferred carriers for sidelink transmission. In some examples, the sidelink message may be a first PC5-RRC reconfiguration message.

The processor and the transceiver of the first WTRU may be configured to select at least a first carrier for unicast sidelink transmission with the second WTRU. The first carrier may be selected from the set of preferred carriers based on a condition that the first carrier meets the carrier selection criteria. The processor and the transceiver of the first WTRU may be configured to determine that the first carrier cannot be used for broadcast sidelink transmission. The processor and the transceiver of the first WTRU may be configured to select at least a second carrier that is not in the set of preferred carriers for broadcast sidelink transmission. The processor and the transceiver of the first WTRU may be configured to send an indication of the selected first and second carriers to the second WTRU in a second message. In some examples, the indication may be sent with a second PC5 RRC reconfiguration message.

In some embodiments, the processor and the transceiver of the first WTRU may be configured to send a unicast transmission to the second WTRU using a selected resource of the first carrier, and to send a multicast/broadcast transmission using a selected resource of the second carrier.

In some examples, the carrier selection criteria may comprise a channel busy ratio (CBR) threshold. The first WTRU may be configured to select the first carrier from the set of preferred carriers based on a condition that the first carrier has a CBR that is below the CBR threshold. Further, in some embodiments, the processor and the transceiver of the first WTRU are configured to select the second carrier for broadcast sidelink transmission based on the second carrier having the lowest CBR out of a plurality of carriers that are not in the set of preferred carriers.

In some examples, the carrier selection criteria may comprise a received signal power (RSRP) threshold. The first WTRU may be configured to select the first carrier from the set of preferred carriers based on a condition that the first carrier has a measured RSRP that is above the RSRP threshold. In some examples, the carrier selection criteria may comprise a listen-before-talk (LBT) failure threshold. The first WTRU may be configured to select the first carrier from the set of preferred carriers based on a condition that the first carrier has experienced LBT failure less than the LBT failure over a preconfigured time period. In some examples, the carrier selection criteria may comprise a hybrid automatic repeat request (HARQ) threshold. The first WTRU may be configured to select the first carrier from the set of preferred carriers based on a condition that the first carrier has a ratio of ACK to NACK that is above the HARQ threshold.

The processor and the transceiver of the first WTRU may be configured to receive a second sidelink message from the second WTRU indicating a set of non-preferred carriers for sidelink transmission, where the set of non-preferred carriers comprises the second carrier. The processor and the transceiver of the first WTRU may be configured to select the second carrier for broadcast sidelink transmission based on a condition that the second carrier meets second carrier selection criteria. In some examples, the second carrier selection criteria may be different than the carrier selection criteria used to select the first carrier for unicast sidelink transmission.

Further, in some examples, the disclosure relates to a WTRU that includes a processor and memory that may be configured to receive one or more preferred carriers associated with a second WTRU. The WTRU may be configured to trigger carrier reselection based on receiving the one or more preferred carriers and to perform carrier selection using the one or more preferred carriers. The WTRU may prioritize the one or more preferred carriers. The WTRU may be configured to determine a number of carriers to select based on the one or more preferred carriers. The WTRU may be configured to select one or more carriers based on the one or more preferred carriers, where for example, the selected carrier may be restricted based on the one or more preferred carriers.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart of an example procedure 200 performed by a WTRU for coordinating carrier usage in multicarrier sidelink.

### DETAILED DESCRIPTION

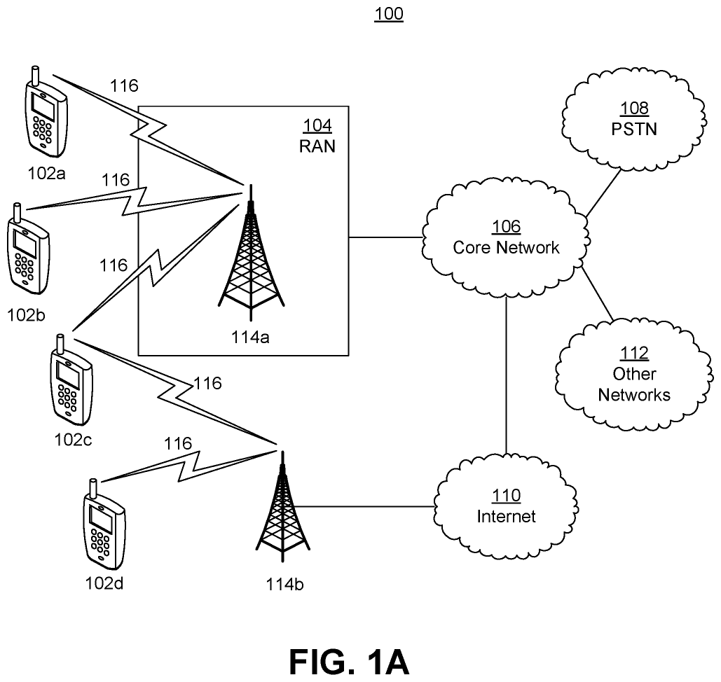

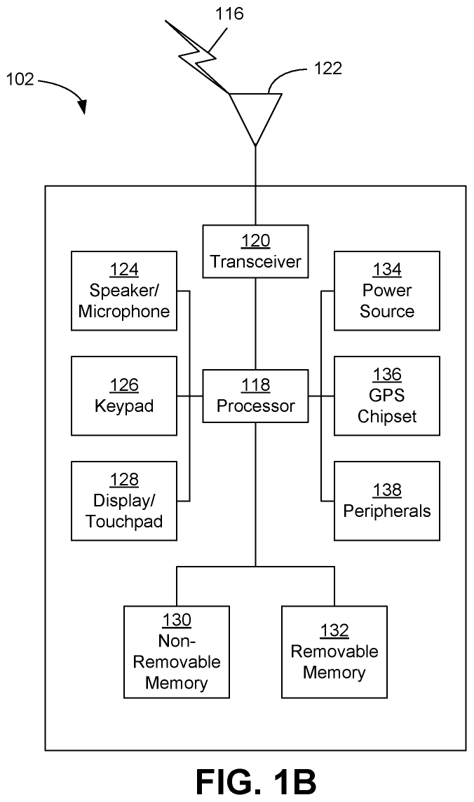

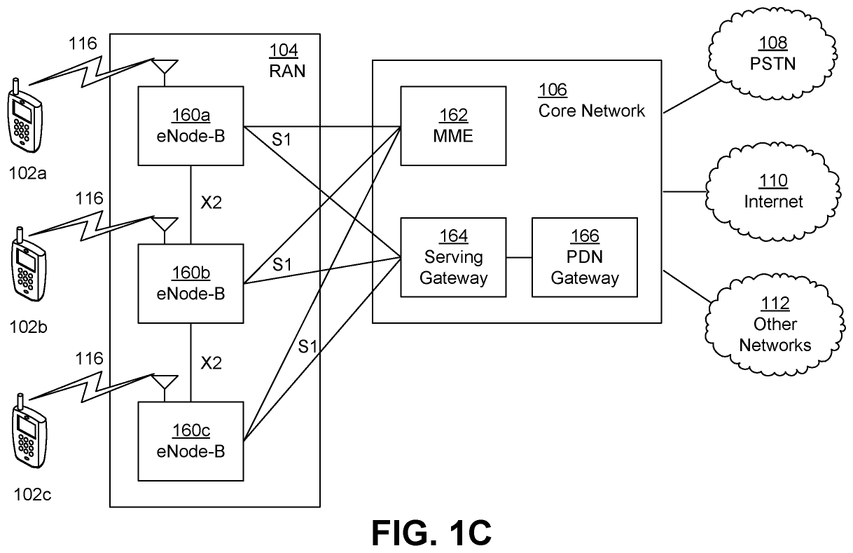

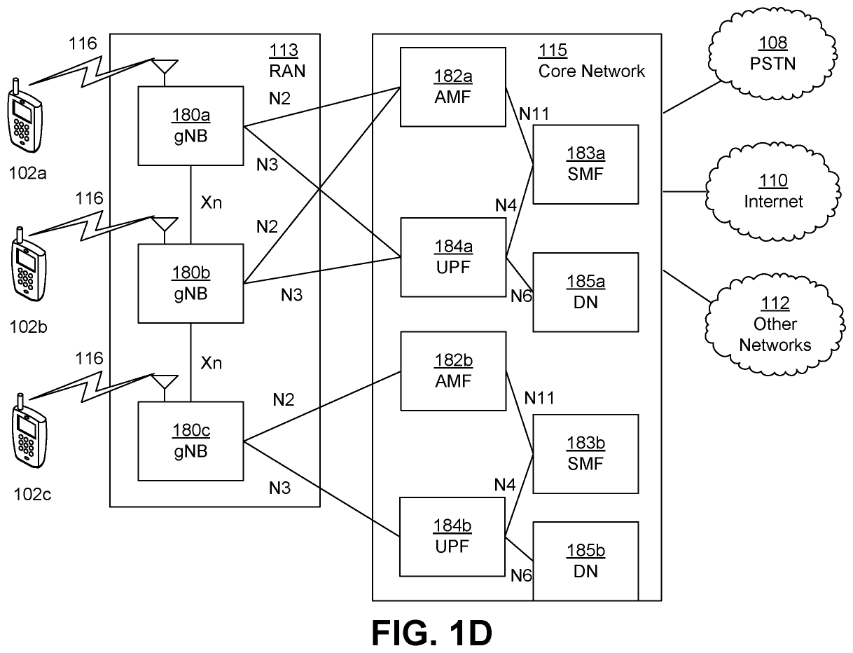

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATS, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The WTRU may trigger/perform carrier selection and LCP by prioritizing a set of preferred carriers indicated by a peer WTRU. The transmitting WTRU (e.g., a TX WTRU) may receive a PC5 radio resource control (RRC) message from a peer WTRU indicating a set of preferred carriers. The TX WTRU may also receive a PC5-RRC message from a peer WTRU indicating a change in the set of preferred carriers.

Following unicast link establishment or if the WTRU is using a carrier for transmission to the peer WTRU which may not be in the list of preferred carriers of the receiving WTRU (RX WTRU), the WTRU (e.g., the TX WTRU) may trigger a transmission carrier reselection procedure. Following unicast link establishment or if the WTRU is using a carrier for transmission to the peer WTRU which may not be in the list of preferred carriers of the RX WTRU, the WTRU (e.g., the TX WTRU) may use a higher channel busy ratio (CBR) threshold to determine whether the carrier may be selected, when a carrier is in the list of preferred carriers of the RX WTRU. The TX WTRU may select a number of allowed carriers, for example, by starting with the carriers that are preferred carriers of at least one peer WTRU in a unicast link, and then in order of CBR. The TX WTRU may also inform a peer WTRU (e.g., using a PC5 radio resource control (RRC) message) which (if any) of the selected carriers may be a preferred carrier of the peer WTRU. The TX WTRU may select a sidelink grant on a selected carrier. If the grant occurs on a carrier which is not a preferred carrier of a peer WTRU, and the WTRU selected at least one carrier that is in the set of preferred carriers of the peer WTRU, the WTRU (e.g., the TX WTRU) may select a logical channel which may not be associated with the said peer WTRU for transmission on the grant.

Vehicular communication may be a mode of communication whereby WTRUs may communicate with each other directly. There may be more than one scenario for vehicle-to-everything (V2X) operations. One scenario may be an in-coverage scenario, where WTRUs may receive assistance from the network to start transmitting and receiving V2X messages. Another scenario may be an out of coverage scenario, where WTRUs may use one or more pre-configured parameters to start transmitting and receiving V2X messages.

V2X communication may be supported and may be inspired from work associated with Device-to-Device (D2D) communications. The V2X communication services may comprise different types: Vehicle to Vehicle (V2V), in which Vehicular WTRUs may communicate with each other directly; Vehicle to infrastructure (V2I), in which vehicular WTRUs may communicate with RSUs/eNBs; Vehicle to Network (V2N), in which vehicular WTRUs may communicate with core network; and Vehicle to Pedestrian (V2P) in which vehicular WTRUs may communicate with WTRUs with special conditions (e.g., low battery capacity).

LTE may define two modes of operation in V2X communication. When in mode (e.g., Mode 3), the network may give the WTRU a scheduling assignment for V2X sidelink transmission. When in mode (e.g., Mode 4), the WTRU may autonomously select the resources from a configured/pre-configured resource pool. V2X LTE may define one or more (e.g., two) categories of resource pools, for example, receiving pools which may be monitored for receiving V2X transmission, and V2X transmitting pools which may be used by WTRUs to select the transmission resource in a mode (e.g., Mode 4). The transmitting pools may not be used by WTRUs configured in a mode (e.g., Mode 3).

In LTE, the resource pools may be semi-statically signaled to WTRUs via RRC signaling. In Mode 4, the WTRU uses sensing before selecting a resource from the RRC configured transmitting pool. LTE V2X does not support dynamic resource pools reconfiguration; pool configuration may only be carried via SIB and/or dedicated RRC signaling.

NR inherited the two modes of resource allocation from LTE. In NR, a mode (e.g., Mode 1) resource allocation may correspond to gNB scheduled resource allocation. While in a mode (e.g., Mode 2) resource allocation may correspond to WTRU autonomous resource allocation. Both the concept of resource pools and sensing for mode 2 resource allocation may be used.

Carrier aggregation (CA) in sidelink may be supported for V2X sidelink communication. CA in sidelink may apply to both in-coverage WTRUs and out-of-coverage WTRUs. For CA in sidelink, neither primary component carrier nor secondary component carriers may be defined. Each resource pool (pre)configured for V2X sidelink communication transmission and/or reception may be associated with a single carrier. When a WTRU supporting CA in sidelink uses autonomous resource selection, it may perform carrier selection and may select one or more carriers, which may be used for V2X sidelink communication transmission. The carrier selection may be performed at MAC layer. The carrier selection may be performed at MAC layer depending on the CBR of the (pre)configured carriers for V2X sidelink communication and the PPPP(s) of the V2X messages to be transmitted. The carrier reselection may be performed when resource reselection is triggered and/or is triggered for each sidelink process. To avoid frequent switching across different carriers, the WTRU may keep using a carrier already selected for transmission, for example, if the measured CBR on this carrier may be lower than a (pre)configured threshold. All selected carriers may have the same synchronization reference and/or the same synchronization priority configuration. For a WTRU using autonomous resource selection, logical channel prioritization may be performed for a sidelink resource on a carrier, for example, depending on the CBR measured on the carrier and the PPPP of the sidelink logical channels.

In LTE, CA may be supported for broadcast (e.g., only for broadcast). The transmission carriers may be selected by the TX WTRU based on the carriers configured by upper layers for the services (i.e., L2 ID) being transmitted, and/or by taking CBR into account (e.g., to ensure equal usage of resources).

Unicast operation may allow a WTRU to limit the number of carriers it needs to monitor (and for example may limit power consumption) by agreeing on a subset (e.g., a smaller set) of carriers with the peer WTRU. In a system where WTRUs may use multiple unicast links, the number of carriers that any WTRU may need to monitor may become larger and may exceed the WTRU's capability. Coordination of the carriers used in a system that considers the carriers used by the WTRU in both unicast as well as groupcast/broadcast may be needed.

The TX WTRU and/or RX WTRU may perform a coordination of carriers used for transmission by the TX WTRU, (e.g., both) for transmission to the RX WTRU, and/or (e.g., also) for other transmissions (e.g., to other TX WTRUs in unicast, and/or for groupcast/broadcast transmissions by the TX WTRU). Carrier coordination may be part of PC5-RRC reconfiguration procedure which may occur after unicast link establishment procedure.

The TX WTRU may request, from the RX WTRU, a set of preferred carriers. For example, the TX WTRU may receive a message (e.g., a sidelink message, such as a PC5 RRC reconfiguration message) from the RX WTRU that indicates a set of preferred carriers for sidelink transmission. Alternatively, or in conjunction, the RX WTRU may transmit (e.g., autonomously transmit) to the TX WTRU, the set of preferred carriers of the RX WTRU, as per triggers described herein.

Following resource selection by the TX WTRU using the preferred carriers of the RX WTRU, the TX WTRU may indicate the actual selected carriers to the RX WTRU. The TX WTRU may transmit the actual selected carriers during (e.g., one, more or all) carrier/resource (re)selection operations of the TX WTRU. Alternatively, or in conjunction, the TX WTRU may transmit the selected carriers (e.g., only) in certain conditions associated with carrier selection. The TX WTRU may indicate the selected carriers (e.g., only) when the TX WTRU may not be able to select the preferred carriers provided by the RX WTRU. The TX WTRU may indicate the selected carriers, and/or information related to the preferred carriers, when any or all of the preferred carriers did not meet other selection criteria at the TX WTRU and/or discussed herein. The TX WTRU, following carrier/resource (re)selection, may trigger a message to the RX WTRU for these purposes (e.g., and other purposes). Such a message may come as a PC5 RRC reconfiguration message. The RX WTRU may, if the carriers selected by the TX WTRU are not acceptable to the RX WTRU, and/or due to the inability of the TX WTRU to transmit using some and/or all of the preferred carriers, send a reconfiguration failure message in response to the reconfiguration. If the RX WTRU sends a reconfiguration failure message, the RX WTRU and/or TX WTRU may assume one or more of: the unicast link is released; the RX and TX WTRU may use the previous list of carriers which was agreed between them; the RX and TX WTRU may use a default carrier, or a subset of carriers which was agreed as a default carrier; the RX and TX WTRU may use (e.g. only use) a single carrier for communication; and/or may not use multiple carriers that could have been used if the coordination was successful.

An RX WTRU may determine a list of preferred carriers to send to the TX WTRU. The RX WTRU may send a list of carriers to the TX WTRU. Such a list may be sent via one or more of: SL using SL MAC CE, PC5-RRC signaling, and/or PC5-S signaling of PHY layer signaling (e.g., SCI). The RX WTRU may send the list of carriers used via a combination of signaling. For example, (e.g., one or more, or all) possible carriers may be sent via SL RRC signaling, and/or configured by the network via UMTS Air Interface (e.g., the Uu interface) RRC signaling. The RX WTRU may send a bitmap of the preferred carriers to the TX WTRU using MAC CE and/or PHY signaling. The RX WTRU may send the changed carriers (e.g., as a delta signaling) since the last carriers may be sent to the TX WTRU.

The RX WTRU may refer to the WTRU which may be sending the list of preferred carriers (e.g., since the list of preferred carriers may be used by the WTRU which may be referred to as the TX WTRU to perform its own carrier selection). The RX WTRU may also have its own transmissions scheduled. The selection of the preferred carriers may involve criteria related to its own transmissions.

The list of preferred carriers may comprise the carriers which the RX WTRU may prefer the TX WTRU to use for transmissions on the unicast link with that TX WTRU (e.g., a preference may be indicated, but transmission may still be possible on other carriers). In an example, the list of preferred carriers may comprise the carriers which the RX WTRU supports for reception. For example, the RX WTRU may receive (e.g., only receive) on the preferred carriers (e.g., and not on other carriers). The list of preferred carriers may comprise the carriers which may be the best options for the TX WTRU to perform transmission on (e.g., from the perspective of performance, channel quality, interference, and/or the like), for example, as determined by the RX WTRU. The list of preferred carriers, as referred to herein, may consist of any one or more of the above.

In some examples, the list of preferred carriers may comprise the carriers which may be the best options for the TX WTRU to perform transmission on from the perspective of capability at the RX WTRU. For example, the list of preferred carriers may comprise the carriers which may be the best options for the TX WTRU to be able to monitor on all the carriers and/or as well as other carriers that the RX WTRU may be monitoring on for other links/transmissions. This may be considered from the perspective of missed reception times (e.g., outside of the preferred carriers, the RX WTRU may not be able to monitor some carriers during some periods of time), and/or from the perspective of power savings (e.g., outside of the preferred carriers, the RX WTRU may still be able to monitor but may consume more power, switching, and the like). In some examples, the list of preferred carriers may comprise the carriers which may already be monitored by the RX WTRU for other links and/or other services (e.g., groupcast/broadcast). The RX WTRU may send a list of non-preferred carriers which, for example, may be determined in similar ways as the list of preferred carriers.

The TX WTRU may use any or a combination of the following example criteria to determine the preferred carriers. For instance, the TX WTRU may receive configuration information that indicates the carrier selection criteria. In one example criteria, the set of carriers may be currently monitored by the RX WTRU for other links and/or services. For example, the RX WTRU may send the list of carriers configured to be monitored by the RX WTRU for any unicast link, groupcast services, and/or the like.

In some examples, the criteria to determine the preferred carriers (e.g., by the TX WTRU) may include SL measurements (e.g., CBR, sidelink (SL) reference signal received power (RSRP), SL channel quality indicator (CQI), received signal strength indicator (RSSI), and/or the like). For example, the RX WTRU may send the set of carriers where SL CBR may be measured below a threshold. Alternatively or additionally, the RX WTRU may send the set of carriers where the measured SL RSRP/SL CQI of receptions may be above a threshold. Alternatively or additionally, the RX WTRU may send the set of carriers where the received SL RSRP/SL CQI received from other WTRUs (e.g., as measured by the other WTRUs) may be above a threshold.

In some examples, the criteria to determine the preferred carriers (e.g., by the TX WTRU) may include a cast type associated with expected receptions/transmissions on those carriers. For example, the RX WTRU may send the set of carriers where it may be performing reception of unicast and/or groupcast/broadcast (e.g., unicast only and/or groupcast/broadcast only). For example, any of the example criteria discussed herein may be specific to the cast type of receptions on that carrier. For example, the RX WTRU may send one or more or all carriers with unicast reception (e.g., only) having a CBR above a threshold. For instance, the RX WTRU may use a first threshold CBR for carriers with reception of one cast (e.g., unicast reception only). Alternatively or additionally, the RX WTRU may use a second CBR for carriers with reception of another cast (e.g., groupcast/broadcast reception). For example, the RX WTRU may send the list of carriers on which it may be performing reception for one cast type for which one measurement criteria may be satisfied (e.g., CBR may be above a threshold). Further, alternatively or additionally, the RX WTRU may send the list of carriers on which it may be performing reception of another cast type (e.g., for which a different measurement criteria may be satisfied (e.g. SL RSRP may be above a threshold).

In some examples, the criteria to determine the preferred carriers (e.g., by the TX WTRU) may include a mode (e.g., mode 1 vs mode 2). For example, the RX WTRU may send the carriers on which it may be performing its own transmissions using mode 1 or mode 2. The RX WTRU may send a different set of carriers determined based on a different criteria herein for the case where it may be configured with mode 1 transmissions as compared to the case where it may be configured with mode 2 transmissions.

In some examples, the criteria to determine the preferred carriers (e.g., by the TX WTRU) may include carriers on which a failure event may be observed or not observed, possibly within a recent (e.g., configured) time period. For example, the WTRU may send the carriers on which SL RLF may have been or may be detected, preemption may have been or may be triggered, unicast link failure (e.g., reconfiguration failure) may have occurred or may occur, etc.

In some examples, the criteria to determine the preferred carriers (e.g., by the TX WTRU) may include sensing capability and/or sensing results. For example, the WTRU (e.g., the RX WTRU) may send the carriers on which it may be capable of performing sensing. The WTRU may send the carriers on which it may be performing a specific type of sensing (e.g., partial sensing vs full sensing). For example, the WTRU may send the carriers where sensing results may meet some specific criteria. For instance, WTRU may be able to find a certain percent of resources available when performing sensing.

In some examples, the criteria to determine the preferred carriers (e.g., by the TX WTRU) may include occupancy/business of the RX WTRU on a carrier for transmission (for example, from the perspective of the WTRU's own resource usage and/or the number of links). For example, the WTRU (e.g., the RX WTRU) may send the carriers on which its CR may be above or below a threshold. The WTRU may send the carriers on which it may have a periodic HARQ process configured. For example, the WTRU may send the carriers on which the number of HARQ processes using the carrier may be above or below a threshold. The WTRU may send the carriers on which the amount of SL resources used for transmission by the WTRU over a configured time period may be above a threshold. The WTRU may send the carriers in which the number of unicast links that use the carriers for transmission may be above a threshold. The WTRU may send the carriers which may be or may have been selected for its own transmission during the last carrier selection procedure.

In some examples, the criteria to determine the preferred carriers (e.g., by the TX WTRU) may include occupancy/business of the RX WTRU on a carrier for reception. For example, the WTRU may send the carriers on which the number of unicast link used in reception by the RX WTRU may be above a threshold. The WTRU may send the carriers on which the number of received SL transmissions intended for the RX WTRU may be larger than a threshold.

As noted above, combinations of the above criteria may be possible. For example, the RX WTRU may send the list of carriers configured to be monitored by the RX WTRU and for which the SL CBR may be below a threshold.

The RX WTRU may trigger transmission of the set of preferred carriers. Such transmission may occur based on certain triggers. For example, the RX WTRU may send the set of preferred carriers upon receiving an explicit/implicit request from the TX WTRU. For example, an explicit request (e.g., via PC5-RRC message) may be sent by the TX WTRU, in which the RX WTRU may send the set of carriers. Alternatively or additionally, the RX WTRU may send the set of carriers based on an explicit request, such as in response to other messaging by the TX WTRU, such as one or more of: reception of a PC5 reconfiguration; reception of a CQI request; reception of a unicast release message; reception of an IUC (inter WTRU coordination) request message. Alternatively or additionally, the RX WTRU may send the set of preferred carriers upon any change in the conditions/criteria for determining the preferred carriers.

Alternatively, or in conjunction, the RX WTRU may send the set of preferred carriers upon any change of the preferred carriers, with respect to the last time the preferred carriers were sent to the TX WTRU. For example, the RX WTRU may send the set of preferred carriers upon a change of the preferred carriers that meet one or more criteria. In some examples, the one or more criteria comprises criteria based on the number of preferred carriers. For example, if the preferred carriers may have changed and the number of preferred carriers may be above a threshold. In some examples, the one or more criteria comprises criteria based on addition or removal of carriers. For example, if the preferred carriers have changed and may have resulted in the addition of new carriers (e.g., only), the removal of carriers (e.g., only), the replacement of one carrier by another carrier, and/or the like. In some examples, the one or more criteria comprises criteria based on the number of changed carriers. For example, if the preferred carriers may have changed and/or the number of carriers that may have changed may be larger than a threshold. In some examples, the one or more criteria comprises criteria based on the carriers which may have changed. For example, if the preferred carriers have changed, and a change may have occurred on one or more specific carriers. In some examples, the one or more criteria comprises criteria which may be based on whether carriers changed with respect to the carriers used/selected by the TX WTRU. For example, if the preferred carriers have changed, and the change may affect one of the carriers selected by the TX WTRU and/or indicated to the RX WTRU.

The RX WTRU may be configured with periodic evaluation/determination of the preferred carriers. Alternatively, or in conjunction, the RX WTRU may determine the preferred carriers and/or send the new preferred carriers to the TX WTRU at the occurrence of any one or more of the following events. In some examples, the RX WTRU may determine the preferred carriers and/or send the new preferred carriers to the TX WTRU when RX WTRU may perform carrier and/or resource selection for its own transmissions. Alternatively or additionally, the RX WTRU may determine the preferred carriers and/or send the new preferred carriers to the TX WTRU when RX WTRU initiates/completes unicast link establishment with the TX WTRU and/or another WTRU.

In some examples, the RX WTRU may determine the preferred carriers and/or send the new preferred carriers to the TX WTRU when RX WTRU initiates/completes sidelink reconfiguration. Alternatively or additionally, the RX WTRU may determine the preferred carriers and/or send the new preferred carriers to the TX WTRU when RX WTRU releases the unicast link with another WTRU. In some examples, the RX WTRU may determine the preferred carriers and/or send the new preferred carriers to the TX WTRU when RX WTRU receives a reconfiguration from the network, potentially providing a list of SL carriers to use, a list of rules to determine the preferred carriers, or the like. In other examples, the RX WTRU may determine the preferred carriers and/or send the new preferred carriers to the TX WTRU when an event related to sensing on one or more of the carriers occurs (e.g., pre-emption detected).

In some examples, the RX WTRU may determine the preferred carriers and/or send the new preferred carriers to the TX WTRU when detection of SL RLF occurs with another WTRU. Alternatively or additionally, the RX WTRU may determine the preferred carriers and/or send the new preferred carriers to the TX WTRU when RX WTRU performs/completes/fails RRC connection. In some examples, the RX WTRU may determine the preferred carriers and/or send the new preferred carriers to the TX WTRU when RX WTRU receives RRC connection release. In some examples, the RX WTRU may determine the preferred carriers and/or send the new preferred carriers to the TX WTRU when RX WTRU may be reconfigured (e.g., by the network, and/or by a peer WTRU) with any change in the sidelink parameters. In some examples, the RX WTRU may determine the preferred carriers and/or send the new preferred carriers to the TX WTRU when any other event related to a change in the conditions described herein for determining the preferred carriers occurs.

The TX WTRU may trigger carrier reselection and/or resource reselection upon reception of the set of preferred carriers. The TX WTRU may trigger carrier/resource reselection (e.g., only) when one or more criteria associated with the carriers provided in the list of preferred carriers is met. The TX WTRU may trigger carrier reselection and/or resource reselection when the set of preferred carriers may have changed compared to when the last set of preferred carriers was sent. The TX WTRU may trigger carrier reselection and/or resource reselection when the number of preferred carriers is different compared to when the last set of preferred carriers was sent.

The TX WTRU may trigger carrier reselection and/or resource reselection when there is a difference in the set of selected carriers and the set of preferred carriers received. For example, the TX WTRU may trigger carrier reselection and/or resource reselection when the preferred carriers contains one or at least X carriers which are not in the set of selected carriers. The TX WTRU may trigger carrier reselection and/or resource reselection when the set of selected carriers does not include at least one or X carriers which are in the preferred carriers. The TX WTRU may trigger carrier reselection and/or resource reselection when the set of preferred carriers contains at least one carrier which meets a selection criteria. The TX WTRU may trigger carrier reselection and/or resource reselection when the set of preferred carriers does not contain any carriers which meet a selection criteria.

The TX WTRU may use preferred carriers in carrier selection. For example, the TX WTRU may use the preferred carriers received from the RX WTRU in performing carrier selection. Carrier selection may refer to one or more of: determining the allowable carriers for transmission of a particular or multiple L2 IDs; determining the actual carriers used for transmission of a particular or multiple L2 IDs; selecting the actual carriers for transmission from the set of allowable carriers; determining the specific carriers that can be used for unicast versus the carriers which may be used for groupcast/broadcast; determining the amount of time in which one or a number of carriers can be used for transmission; selecting a set of carriers (e.g. a set of preferred carriers) to be sent to a peer WTRU (e.g. in a unicast link); and/or determining the carriers to exclude for transmission of a particular or multiple L2 IDs.

The TX WTRU may use the preferred carriers received from the RX WTRU to perform one or more of the following: The TX WTRU may use the preferred carriers received from the RX WTRU to prioritize, in the carrier selection, the selection of the preferred carriers. The TX WTRU may use the preferred carriers received from the RX WTRU to prioritize, during transmission to the RX WTRU, the preferred carriers. The TX WTRU may use the preferred carriers received from the RX WTRU to determine the number of carriers to select during carrier selection. The TX WTRU may use the preferred carriers received from the RX WTRU to restrict, in carrier selection, the selected carriers to the preferred carriers, to a set of carriers that may contain at least the preferred carriers, to a set of carriers that may not contain any carriers outside of the preferred carriers, to a set of carriers that may contain at least X of the preferred carriers (e.g., where X can be 1, or can be configured, or determined by the WTRU based on other criteria related to resource selection), and/or to a set of carriers that may not contain (e.g., any) of the preferred carriers.

The TX WTRU may prioritize the preferred carriers. For example, the TX WTRU may prioritize the preferred carriers in carrier selection. Prioritization may refer to selecting the preferred carriers first, before selecting other carriers. Prioritization may consist of using a different criteria/condition for carriers which may be preferred carriers compared to carriers which may not be preferred carriers.

The TX WTRU may first select the preferred carriers before selecting other carriers. For example, the TX WTRU may determine a number of carriers for selection. If the number of carriers is larger than the set of preferred carriers, the TX WTRU may first select the preferred carriers and then select other carriers which may not be preferred carriers. For example, in the case where the number of carriers is less than the preferred carriers, the TX WTRU may select only from the preferred carriers, possibly using another criteria. In some examples, the TX WTRU may receive a set of preferred carriers from multiple WTRUs and may select from the preferred carriers which may be common to the most WTRUs before selecting other carriers and/or carriers which may not be preferred carriers.

The TX WTRU may prioritize the preferred carriers by using a different selection criteria and/or condition when selecting a carrier which may be a preferred carrier as compared to selecting a carrier which may be a non-preferred criteria. For example, the TX WTRU may be allowed or may select a carrier based on a criteria, and a condition on that criteria. For example, the TX WTRU may use any one or a combination of the following criteria (and example criteria) to select a carrier. An example criteria used by the TX WTRU to select a carrier may be measured CBR on the carrier. For example, if the measured CBR is below a threshold selection of a carrier may be allowed. An example criteria used by the TX WTRU to select a carrier may be SL measurements reported by a peer WTRU, and/or measured by the said WTRU (e.g. RSRP/CQI). For example, if the measured RSRP/CQI is above a threshold, selection of a carrier may be allowed. An example criteria used by the TX WTRU to select a carrier may be licensed vs unlicensed and/or based on LBT results for unlicensed. For example, if LBT failure has occurred less than a threshold number of times over a (pre)configured past time period, selection of an unlicensed carrier may be allowed. An example criteria used by the TX WTRU to select a carrier may be HARQ feedback. For example, if HARQ feedback indicates that the ratio of ACK to NACK on that carrier is above a threshold, selection of a carrier may be allowed. An example criteria used by the TX WTRU to select a carrier may comprise other criteria which may not be listed here but which may be possible.

In an example, based on the criteria and/or conditions, the TX WTRU may use a first criteria and/or condition when evaluating whether to select a preferred carrier and a second set of criteria and/or conditions when evaluating whether to select a carrier that may not be in the list of preferred carriers.

In some examples, the TX WTRU may use CBR to determine, from the list of supported carriers for transmission, a list of allowed carriers. For example, the TX WTRU may be configured with a first CBR threshold to be applied when evaluating a preferred carrier and a second CBR threshold to be applied when evaluating a non-preferred carriers. The TX WTRU may evaluate each support carriers independently (e.g., one at a time) prior to selection. When evaluating a specific carrier, the WTRU may first determine if the specific carrier is a preferred carrier. If the carrier is a preferred carrier, the WTRU may compare the CBR measured on the carrier with a first threshold and may declare the carrier to be allowed if the measured CBR is below the first threshold. If the carrier is a non-preferred carrier, the WTRU may compare the CBR measured on the carrier with a second threshold and may declare the carrier to be allowed if the measured CBR is below the second threshold. From the list of allowed carriers, the TX WTRU may select a subset of the allowed carriers using the same or other criteria described herein.

In some examples, the TX WTRU may use a different criteria on preferred versus non-preferred carriers to determine, from the list of supported carriers for transmission, a list of allowed carriers. For example, if a supported carrier is a preferred carrier, the TX WTRU may select the supported carrier if the RSRP measured on the carrier by the peer WTRU is above an RSRP threshold. In an example, if a supported carrier is not a preferred carrier, the TX WTRU may select the supported carrier if the CBR measured on the carrier is below a CBR threshold. In an example, for the list of allowed carriers, the TX WTRU may select a subset of the allowed carriers using the same or other criteria described herein.

In some examples, the TX WTRU may use a criteria for selection (e.g., only) on non-preferred carriers (e.g., or only on preferred carriers). For example, the TX WTRU may allow selection of a non-preferred carrier (e.g., from the list of preferred carriers) if the measured CBR is below a CBR threshold. In some examples, the same CBR evaluation may not preferred on a preferred carrier. For the list of allowed carriers, the TX WTRU may select a subset of the allowed carriers using the same or other criteria described herein.

The TX WTRU may prioritize the preferred carriers in transmission. The TX WTRU may prioritize the preferred carriers during transmission to the peer WTRU. For example, the TX WTRU may have a number of selected carriers on which to perform transmission, in which a subset of those carriers may be preferred carriers of one or more peer WTRUs. For example, a carrier may be a preferred carrier of a first peer WTRU, a second carrier may be a preferred carrier of (e.g., either one or both of) a first peer WTRU and a second peer WTRU, and/or a third carrier may not be a preferred carrier with respect to (e.g. one or more or any) peer WTRU.

A grant on a preferred carrier may be prioritized for transmission to the peer WTRU that preferred transmission for it. For example, for a grant on a preferred carrier associated with a first peer WTRU, the TX WTRU may select data intended to the first peer WTRU before any data may be selected for the second peer WTRU if data is available for transmission to the first peer WTRU. In an example, if there is no data available for transmission to the first peer WTRU, the TX WTRU may use the grant for transmission of data to a second peer WTRU. For a grant on a preferred carrier associated with a first peer WTRU, the TX WTRU may apply a higher priority (e.g., may apply an offset to the priority of data available for transmission to make that data seem like higher priority) to the data available for transmission to the first peer WTRU compared to the data available for transmission to a second peer WTRU.

For a grant on a non-preferred carrier, the TX WTRU may select data intended to a second peer WTRU (e.g., not associated with any preferred carrier) before selecting data intended to the first peer WTRU that may be associated with a preferred carrier. In an example, for a grant on a non-preferred carrier, the TX WTRU may apply a higher priority (e.g. may apply an offset to the priority of data available for transmission to make that data seem like higher priority) to the data available for transmission to a second peer WTRU that may not be associated with any preferred carrier e.g., compared to the data available for transmission to a first peer WTRU associated a preferred carrier. In some examples, a grant on a preferred carrier may be used (e.g., only be used) for transmission to the WTRU associated with the preferred WTRU, and the grant may be dropped if there is no data available for transmission to any WTRU that has that carrier as a preferred carrier. In some examples, a grant on a non-preferred carrier may not be used for transmitting data associated with a WTRU that may have provided a list of preferred carriers. The WTRU may select (e.g., only) data associated with transmission to a WTRU (e.g., or to a L2 ID) that may not have provided a preferred list of carriers. In some examples, the above solutions may apply to the case where a preferred carrier may correspond to the carriers agreed for transmission between two peer WTRUs in a unicast link, and/or a non-preferred carrier may comprise any other carrier (e.g., on which transmission of any cast type is possible). Accordingly, the WTRU may select a carrier for unicast sidelink transmission with the RX WTRU, wherein the carrier is selected from the set of preferred carriers based on a condition that the first carrier meets the carrier selection criteria.

The TX WTRU may determine the number of carrier to select based on the preferred carriers. The TX WTRU may use the preferred carriers in determining the number of carriers to be selected. For example, the TX WTRU may determine a number of carriers selected such that the carriers include at least the preferred carriers of all peer WTRUs, and may determine the minimum number of selected carriers as the list of preferred carriers. The TX WTRU may determine a list of allowed carriers from the preferred carriers, and the TX WTRU may select at least a number of carriers that includes the preferred carriers that are allowed.

The TX WTRU may restrict the selected carriers based on a preferred carrier. For example, the TX WTRU may select a set of carriers for transmission by restricting the selection based on the set of preferred carriers from one or more peer WTRUs. In some examples, the selected carriers may be restricted to carriers which were indicated as preferred carriers by at least another WTRU (e.g., only). Further, in some examples, the selected carriers may include at least all of the preferred carriers, possibly indicated by all peer WTRUs. For instance, the selected carriers may contain at least X carriers in the preferred carriers. The TX WTRU may select at least X carriers in the list of preferred carriers sent by the peer WTRU, assuming the peer WTRU may send greater than X carriers. For instance, if the peer WTRU may not send greater than X carriers, the TX WTRU may select one or more or all carriers indicated as preferred (e.g., possibly if they meet some other criteria indicated herein). The value of X may be predetermined or may be configured (e.g., in Uu RRC or transmitted in PC5-RRC).

The value of X may further depend on any one or a combination of the following. The value of X may depend on QoS. For example, the TX WTRU may determine the value of X based on the QoS of transmissions to the peer WTRU. For example, the Sidelink Radio Bearers (SLRBs) may be configured with a value of X, and the WTRU may use the maximum value of X configured for all SLRBs established for transmission to that WTRU. The value of X may depend on CBR. For example, the TX WTRU may be configured with a value of X for each CBR or CBR range measured on the set of carriers (e.g., an average CBR, or a maximum/minimum CBR on the carriers). The value of X may depend on SL measurements. For example, the TX WTRU may be configured with a value of X for each RSRP or RSRP range measured with the peer WTRU. The value of X may depend on cast type. For example, the TX WTRU may be preconfigured with a value of X for each cast type (e.g., use one value for unicast, use a second value for groupcast, etc.).

The RX WTRU may send a list of preferred carriers. Such preferred carriers may represent the list of carriers the RX WTRU is already monitoring. Specifically, the RX WTRU may send the list of carriers associated with groupcast/broadcast L2 IDs the RX WTRU may be interested in receiving, as well as, as an example, the list of carriers associated with all other unicast links set up with other TX WTRUs. For a particular TX WTRU, the RX WTRU may send the list of preferred carriers following PC5-RRC unicast establishment with that TX WTRU. In addition, the RX WTRU may send the list of preferred carriers each time the list of preferred carriers changes. If the RX WTRU releases a unicast link with another TX WTRU which may result in changing the list of carriers on which the RX WTRU is monitoring, the RX WTRU may trigger transmission of a new list of preferred carriers with each of its connected TX WTRUs.

The TX WTRU may use the list of preferred carriers from one or more TX WTRUs in carrier (re)selection. The TX WTRU may perform initial carrier selection based on one or more of these lists. The TX WTRU may trigger carrier reselection upon reception of the preferred carrier list from the RX WTRU. The TX WTRU may trigger carrier reselection if none of the preferred carriers received from the RX WTRU used as one of the currently selected carriers at the TX WTRU.

During carrier selection, the TX WTRU may select a set of carriers based on CBR and may, in an example, use different CBR thresholds for carriers which may be preferred carriers and carriers which may not be preferred carriers. For example, the TX WTRU may determine the allowed carriers as the set of carriers whose CBR may be above a threshold. For instance, for a carrier that is one of the carriers in the preferred set of carrier from any RX WTRU, the TX WTRU may use one CBR threshold. And, for a carrier that may not be a preferred carrier of any RX WTRU, the TX WTRU may use another CBR threshold.

Following determination of the allowed carriers, the TX WTRU may perform selection of a set of carriers for transmission. For example, the TX WTRU may select from the allowable carriers which may be preferred carriers from the RX WTRU. For instance, the TX WTRU may select at least X carriers (e.g., based on QoS) from the allowable carriers. The selection may be in order of the lowest CBR to the highest CBR until X carriers may be selected. The TX WTRU may then select additional carriers based on its own needs. For example, if the TX WTRU must transmit on a carrier which is not part of the preferred carriers, the TX WTRU may select additional allowed carriers to perform transmission to all groupcast/broadcast services. In some examples, the non-preferred carriers may also be selected from lowest to highest CBR. In some examples, the TX WTRU may select a carrier for broadcast that is in the set of preferred carriers (e.g., but that is different from the carrier selected for unicast with the RX WTRU). Following carrier selection, the TX WTRU may send the selected carriers to the RX WTRU (e.g., in PC5-RRC signaling), such as the carrier(s) to be used for unicast sidelink transmission and the carrier(s) to be used for broadcast sidelink transmission. The TX WTRU may indicate the carriers that may be used by the TX WTRU to transmit data to the RX WTRU. For example, this may be limited to the carriers in the preferred carrier list, if the carriers in the preferred carrier list were allowed carriers as determined by the TX WTRU.

Following reception of the used carriers by the TX WTRU, the RX WTRU may determine whether the use of the carriers by the TX WTRU results in exceeding the capabilities (e.g., the number of carriers monitored) at the RX WTRU. If the use of the carriers by the TX WTRU results in exceeding the capabilities (e.g., number of carriers monitored) at the RX WTRU, the RX WTRU may perform any one or a combination of the following: send an updated list of preferred carriers to one or more TX WTRUs indicating a changed/reduced set of carriers; send a connection reconfiguration failure to the TX WTRU that may indicate the carriers being used in the unicast link.

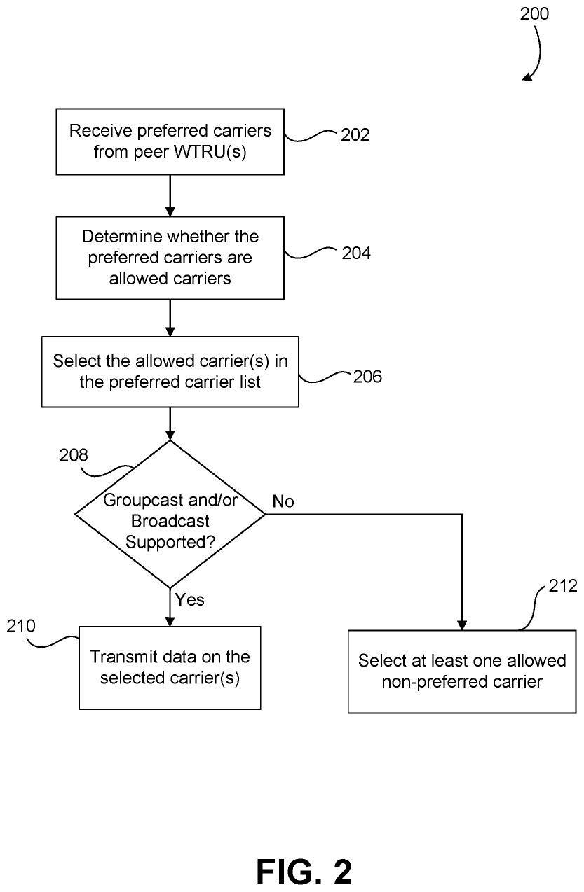

FIG. 2 is a flowchart of an example procedure 200 performed by a WTRU (e.g., a TX WTRU) for coordinating carrier usage in multicarrier sidelink. The WTRU (e.g., the TX WTRU) may perform the procedure 200 to determine one or more carriers for communication with one or more peer WTRUs over unicast and/or broadcast. At 202, the WTRU may receive a message (e.g., a sidelink message) from a peer(s) RX WTRU indicating a set of preferred carriers for sidelink transmission. In some examples, the sidelink message may be a PC5-RRC reconfiguration message.

Further, in some examples, the WTRU may receive configuration information indicating carrier selection criteria. The configuration information may configure the WTRU to select carriers for communicating with one or more peer WTRUs based on any combination of CBR, RSRP, LBT, HARQ, etc. For example, the carrier selection criteria may comprise a CBR threshold, and the WTRU may be configured to select a carrier from the set of preferred carriers based on a condition that the carrier has a CBR that is below the CBR threshold. In some examples, the carrier selection criteria may comprise an RSRP threshold, and the WTRU may be configured to select a carrier from the set of preferred carriers based on a condition that the carrier has a measured RSRP that is above the RSRP threshold. In some examples, the carrier selection criteria may comprise a LBT failure threshold, and the WTRU may be configured to select a carrier from the set of preferred carriers based on a condition that the carrier has experienced LBT failure less than the LBT failure (e.g., over a preconfigured time period). In some examples, the carrier selection criteria may comprise a HARQ threshold, and the WTRU may be configured to select a carrier from the set of preferred carriers based on a condition that the carrier has a ratio of ACK to NACK that is above the HARQ threshold.

At 204, the WTRU may determine which of the preferred carriers are allowed carriers. The WTRU may determine whether a preferred carrier is an allowed carrier based on one or more criteria. For example, the WTRU may use any one or a combination of the following criteria to select a carrier from the preferred carriers received at 202. The example criteria used by the WTRU to determine whether a carrier is an allowed carrier may be the measured CBR on the carrier. For example, the WTRU may determine that the carrier is an allowed carrier if the measured CBR is below the CRB threshold. The example criteria used by the WTRU to determine whether a carrier is an allowed carrier may be SL measurements reported by a peer WTRU, and/or measured by the WTRU (e.g., RSRP and/or CQI). The WTRU may determine that the carrier is an allowed carrier if the measured RSRP and/or CQI is above a threshold. The example criteria used by the WTRU to determine whether a carrier is an allowed carrier may be whether the carrier is in the licensed vs unlicensed band, and/or based on LBT results for a carrier in the unlicensed band. The WTRU may determine that the carrier is an allowed carrier if the LBT failure has occurred less than a threshold number of times over a (pre)configured past time period. The example criteria used by the WTRU to determine whether a carrier is an allowed carrier may be HARQ feedback. The WTRU may determine that the carrier is an allowed carrier if the HARQ feedback indicates that the ratio of ACK to NACK on that carrier is above a threshold. The example criteria used by the WTRU to select a carrier may comprise other criteria which may not be listed here but which may be possible.

At 206, the WTRU may select the allowed carrier(s) in the preferred carrier list. For instance, the WTRU may select at least one allowed carrier for unicast sidelink transmission with the peer RX WTRU (e.g., the WTRU that sent the list of preferred carriers at 202). In some examples, the WTRU may select the allowed carrier from the set of preferred carriers based on a condition that the allowed carrier meets the carrier selection criteria (e.g., received in the configuration information). Further, in some examples, the WTRU may select allowed carrier(s), starting with the carriers that are preferred carriers of at least one peer WTRU in a unicast link, and then in order of CBR.

At 208, the WTRU may determine whether the selected allowed carrier(s) are groupcast/broadcast supported. If the WTRU determines that the selected allowed carrier(s) are groupcast/broadcast supported, the WTRU may transmit data on the selected allowed carrier(s) at 210. If the WTRU determines that the selected allowed carrier(s) are not groupcast/broadcast supported, the WTRU may select at least one allowed non-preferred carrier, for example, for broadcast sidelink transmission. In some examples, the WTRU may also send an indication of the selected carriers for unicast transmission and/or for broadcast transmission to the peer WTRU(s) in a message (e.g., a PC5 RRC reconfiguration message). As such, the WTRU may prioritize the use of preferred carriers for unicast sidelink transmission with one or more peer WTRUs, and in stances where the preferred carriers are not suitable for broadcast sidelink transmission, the WTRU may select an additional carrier(s) for broadcast transmission.

What is claimed is:

1-18. (canceled)

19. A first wireless transmit/receive unit (WTRU) comprising:
a processor configured to:
receive an indication of a first set of carriers for sidelink transmissions;
receive a message indicating a second set of carriers, wherein the second set of carriers are carriers where a second WTRU supports reception of sidelink transmissions;
select a plurality of carriers for a sidelink transmission, wherein the plurality of carriers are selected based on the first set of carriers and the second set of carriers, wherein the sidelink transmission is a groupcast or broadcast transmission; and
send the sidelink transmission via the plurality of carriers to at least one other WTRU, wherein the plurality of carriers comprises at least one carrier from the second set of carriers.

20. The first WTRU of claim 19, wherein the second WTRU does not support reception of sidelink transmissions on carriers other than the second set of carriers.

21. The first WTRU of claim 19, wherein the plurality of carriers comprises at least one carrier that is part of the first set of carriers but is not part of the second set of carriers.

22. The first WTRU of claim 19, wherein the first set of carriers comprise one or more carriers that the first WTRU is configured to send one or more sidelink transmissions.

23. The first WTRU of claim 19, wherein the processor is configured to:
select the plurality of carriers for the sidelink transmission based on a quality of service (QoS) associated with the sidelink transmission.

24. The first WTRU of claim 19, wherein the second set of carriers of the second WTRU are associated with a quality of service (QoS).

25. The first WTRU of claim 19, wherein the processor is configured to:
select the plurality of carriers for the sidelink transmission based on a received signal received power (RSRP) threshold associated with the sidelink transmission, wherein the plurality of carriers are selected based on a condition that the plurality of carriers have a measured RSRP that is above the RSRP threshold.

26. The first WTRU of claim 19, wherein the processor is configured to:
select the plurality of carriers for the sidelink transmission based on a channel busy ratio (CBR) threshold associated with the sidelink transmission, wherein the plurality of carriers are selected based on a condition that the plurality of carriers have a CBR that is below the CBR threshold.

27. The first WTRU of claim 19, wherein the processor is configured to:
select the plurality of carriers for the sidelink transmission based on a listen-before-talk (LBT) failure threshold associated with the sidelink transmission, wherein the plurality of carriers are selected based on a condition that the plurality of carriers experience LBT failure less than the LBT failure threshold over a preconfigured time period.

28. The first WTRU of claim 19, wherein the processor is configured to:
select the plurality of carriers for the sidelink transmission based on a hybrid automatic repeat request (HARQ) threshold associated with the sidelink transmission, wherein the plurality of carriers are selected based on a condition that the plurality of carriers have a ratio of ACK to NACK that is above the HARQ threshold.

29. A method performed by a first wireless transmit/receive unit (WTRU), the method comprising:
receiving an indication of a first set of carriers for sidelink transmissions;
receiving a message indicating a second set of carriers, wherein the second set of carriers are carriers where a second WTRU supports reception of sidelink transmissions;
selecting a plurality carriers for a sidelink transmission, wherein the plurality of carriers are selected based on the first set of carriers and the second set of carriers, wherein the sidelink transmission is a groupcast or broadcast transmission; and
sending the sidelink transmission via the plurality of carriers to at least one other WTRU, wherein the plurality of carriers comprises at least one carrier from the second set of carriers.

30. The method of claim 29, wherein the second WTRU does not support reception of sidelink transmissions on carriers other than the second set of carriers.

31. The method of claim 29, wherein the plurality of carriers comprises at least one carrier that is part of the first set of carriers but is not part of the second set of carriers.

32. The method of claim 29, wherein the first set of carriers comprise one or more carriers that the first WTRU is configured to send one or more sidelink transmissions.

33. The method of claim 29, wherein the method further comprises:
selecting the plurality of carriers for the sidelink transmission based on a quality of service (QoS) associated with the sidelink transmission.

34. The method of claim 29, wherein the second set of carriers of the second WTRU are associated with a quality of service (QoS).

35. The method of claim 29, wherein the method further comprises:
selecting the plurality of carriers for the sidelink transmission based on a received signal received power (RSRP) threshold associated with the sidelink transmission, wherein the plurality of carriers are selected based on a condition that the plurality of carriers have a measured RSRP that is above the RSRP threshold.

36. The method of claim 29, wherein the method further comprises:
selecting the plurality of carriers for the sidelink transmission based on a channel busy ratio (CBR) threshold associated with the sidelink transmission, wherein the plurality of carriers are selected based on a condition that the plurality of carriers have a CBR that is below the CBR threshold.

37. The method of claim 29, wherein the method further comprises:
selecting the plurality of carriers for the sidelink transmission based on a listen-before-talk (LBT) failure threshold associated with the sidelink transmission, wherein the plurality of carriers are selected based on a condition that the plurality of carriers experience LBT failure less than the LBT failure threshold over a preconfigured time period.

38. The method of claim 29, wherein the method further comprises:
selecting the plurality of carriers for the sidelink transmission based on a hybrid automatic repeat request (HARQ) threshold associated with the sidelink transmission, wherein the plurality of carriers are selected based on a condition that the plurality of carriers have a ratio of ACK to NACK that is above the HARQ threshold.
